(19) United States
(12) Patent Application Publication
(10) Pub. No.: US 2014/0364174 A1
(43) Pub. Date: Dec. 11, 2014

(54) ON-DEVICE ENERGY ESTIMATION FOR PORTABLE ELECTRONIC DEVICES

(71) Applicant: Apple Inc., Cupertino, CA (US)

(72) Inventors: Amit K. Vyas, San Jose, CA (US); Abhinav Pathak, San Jose, CA (US); David S. Choi, Cupertino, CA (US); Anand Ramadurai, Los Gatos, CA (US); Nathan K. Kupp, Sunnyvale, CA (US); Zheng Zeng, Cupertino, CA (US)

(73) Assignee: Apple Inc., Cupertino, CA (US)

(21) Appl. No.: 14/176,819

(22) Filed: Feb. 10, 2014

Related U.S. Application Data
(60) Provisional application No. 61/832,018, filed on Jun. 6, 2013.

(51) Int. Cl. H04W 52/02

(52) U.S. Cl. CPC H04W 52/0225
USPC 455/574

(57) ABSTRACT

A technique for estimating energy consumption of a portable electronic device is described. During this energy-estimation technique, the portable electronic device determines hardware-state information for communication subsystems that implement different communication protocols, and software-state information for the communication protocols. Then, using models for the communication subsystems, and the hardware-state information and the software-state information, the portable electronic device estimates the energy consumption. Based on the estimated energy consumption, certain percentages of the battery charge may be allotted for different applications or features, battery-life diagnostics may be improved, and useful information may be provided to a user about the battery drain on their portable electronic device.

### CROSS-REFERENCE TO RELATED APPLICATION

This application claims priority under 35 U.S.C. §119(e) to U.S. Provisional Application Ser. No. 61/832,018, entitled “On-Device Energy Estimation for Portable Electronic Devices,” by Amit K. Vyas, Abhinav Pathak, David S. Choi, Anand Ramadurai, Nathan K. Kupp, and Zheng Zeng, Attorney Docket Number APL-P19596USP1, filed on Jun. 6, 2013, the contents of which are herein incorporated by reference.

### BACKGROUND

1. Field

The described embodiments relate to a technique for estimation of energy consumption of a portable electronic device. More specifically, the described embodiments relate to a technique for estimation of energy consumption of a portable electronic device having communication subsystems that implement different communication protocols.

2. Related Art

An important feature of many portable electronic devices, such as smartphones and tablet computers, is the ability to communicate information (e.g., packets) to enable activities, such as: telephony, sending and receiving emails or browsing the Internet. Often, portable electronic devices may communicate such packets using either a wireless local area network (WEAN) connection (such as a Wi-Fi connection to a Wi-Fi network) or a cellular connection to a cellular telephone or data network (such as a 3G or 4G network).

However, communicating packets to and from a portable electronic device consumes energy. Because many portable electronic devices are powered by batteries, reducing energy consumption while still enabling the communication of packets may increase the length of time the portable electronic devices can be used before recharging the battery and, thus, may help improve the user experience.

Nonetheless, it can be difficult to estimate the energy consumption of a portable electronic device. For example, hardware that implements communication subsystems in the portable electronic device may have multiple cores with a variety of states depending on how the portable electronic device is being used. In order to estimate the energy consumption of these cores, a variety of information may be needed, such as a large number of clock states. However, this information is often unavailable, because measuring the clock states typically involves significant energy consumption. In addition, it is difficult to determine how the energy consumption can be attributed to different software applications executing on a portable electronic device from information specifying the clock states.

### SUMMARY

The disclosed embodiments relate to estimation of the energy consumption of a portable electronic device (such as a cellular telephone or a smartphone) that includes communication subsystems that implement different communication protocols. For example, the communication protocols may include one or more of: wideband code division multiple access (W-CDMA), long-term evolution (LTE), evolution-data optimized (EVDO), global system for mobile communications (GSM), and Wi-Fi. By determining hardware-state information for the communication subsystems and software-state information for the communication protocols, the energy consumption of the portable electronic device can be estimated using models for the communication subsystems. These estimates may be replaced by measurements of device energy consumption when the display in the portable electronic device is inactive, and when background services (such as audio and location services) are not being used. Furthermore, the energy consumption can be attributed to different applications executing on the portable electronic device. Accurately estimating the energy consumption of the portable electronic device can be used to: budget energy of the percentage of battery power for different applications, and provide a user useful information about the battery drain on the portable electronic device (such as the energy usage per application).

### BRIEF DESCRIPTION OF THE FIGURES

FIG. 1 presents a block diagram illustrating a portable electronic device in accordance with described embodiments.

FIG. 2 presents a block diagram illustrating a networking subsystem in the portable electronic device of FIG. 1 that includes a cellular subsystem and a WLAN subsystem in accordance with described embodiments.

FIG. 3 presents a block diagram illustrating an operating system, application and subsystems of the portable electronic device of FIG. 1 in accordance with described embodiments.

FIG. 4 presents a flow chart illustrating operations performed when estimating the energy consumption of the portable electronic device of FIG. 1 in accordance with described embodiments.

FIG. 5 presents a drawing illustrating power consumption as a function of time for the portable electronic device of FIG. 1 in accordance with described embodiments.

Note that like reference numerals refer to corresponding parts throughout the drawings. Moreover, multiple instances of the same part are designated by a common prefix separated from an instance number by a dash.

### DETAILED DESCRIPTION

The following description is presented to enable any person skilled in the art to make and use the present embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present embodiments. Thus, the present embodiments are not limited to the embodiments shown, but are to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium. Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

### Overview

In order to appropriately allocate and manage battery power in a portable electronic device (such as a cellular telephone or a smartphone), the energy consumed by the radio for different communication protocols (such as Wi-Fi, cellular telephony or cellular packet data) when different applications are executed by the portable electronic device is estimated. In particular, for each chipset (which is sometimes referred to as a ‘communication subsystem’) that implements a particular communication protocol, such as a particular radio-access technology (e.g., LTE, EVDO, CDMA, GSM, etc.), a predetermined model is used to estimate the energy consumption. The model for a radio-access technology is based on the energy consumed when there is sufficient signal strength on a connection and the incremental energy consumption as function of the transmit power associated with the power-amplifier power. Moreover, the model for each Wi-Fi chipset is based on different factors than those for the radio-access technologies.

This energy-estimation technique may be used to estimate the energy consumed during a remote software update. When a software update occurs, an energy-estimation program module executing on a portable electronic device may instruct firmware executed by a networking subsystem in the portable electronic device (which includes the communication subsystems) to capture or take a snapshot of counters in the networking subsystem. These counters may log hardware-state information associated with operation of a given communication subsystem, such as: the amount of time in an active or connected mode, an amount of time in a sleep mode, and/or an amount of time in different transmit states (e.g., a transmit/receive duty cycle). Moreover, at the end of the software update, another snapshot of the counters is taken. Alternatively or additionally, if the software update lasts longer than a predetermined amount of time (such as five minutes), another snapshot of the counters is taken. In addition, the firmware may capture software-state information associated with a communication protocol implemented by the given communication subsystem, such as an amount of time spent in different software states associated with the communication protocol.

The start and end values of the counters and the software-state information are input into the model in the energy-estimation program module for the given communication subsystem, and the energy consumption is returned. These operations are repeated for different communication subsystems, and the total energy consumption is reported back to the portable electronic device for subsequent use in: managing the battery, updating an available-energy graphic or icon displayed on a user interface, etc.

In addition to software updates, snapshots of the counters and the software-state information may be captured and used to estimate the energy consumed during other triggering events, such as: after a time interval has elapsed, when a memory or cache in the networking subsystem is full, and/or when a processor in the portable electronic device transitions from a sleep mode to an active mode. Depending on the applications executed by the portable electronic device when the snapshots are captured, the energy-estimation program module may use a measured energy consumption of the portable electronic device instead of the estimated energy consumption. In particular, when a display in the portable electronic device is active or when an application uses audio and/or location services, the estimated energy consumption is used. Otherwise, the measured energy consumption may be used. Furthermore, when multiple applications are executed concurrently on the portable electronic device, the energy-estimation program module may calculate the portions of the estimated energy consumption associated with the applications.

We now describe the structure of the portable electronic device that uses the above-described energy-estimation technique.

### Portable Electronic Device

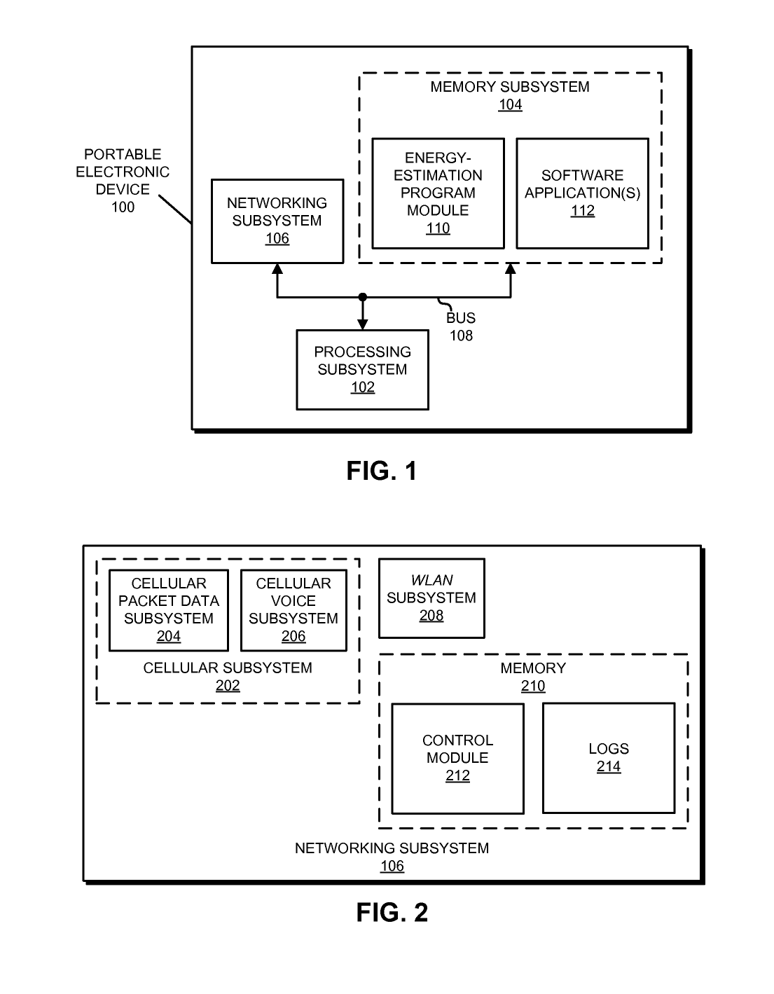

FIG. 1 presents a block diagram illustrating portable electronic device 100 in accordance with described embodiments. Portable electronic device 100 includes processing subsystem 102, memory subsystem 104, and networking subsystem 106 (which is sometimes referred to as an ‘interface circuit’), all coupled together and communicating through bus 108.

Processing subsystem 102 includes one or more devices configured to perform computational operations. For example, processing subsystem 102 can include one or more microprocessors, application-specific integrated circuits (ASICs), microcontrollers, application processors, and/or programmable-logic devices.

Memory subsystem 104 includes one or more devices for storing data and/or instructions for processing subsystem 102, and networking subsystem 106. For example, memory subsystem 104 can include any type of computer-readable storage medium, such as dynamic random access memory (DRAM), static random access memory (SRAM), and/or other types of memory. In addition, memory subsystem 104 can include mechanisms for controlling access to the memory. In some embodiments, memory subsystem 104 includes a memory hierarchy that comprises one or more caches coupled to a memory in portable electronic device 100. In some of these embodiments, one or more of the caches is located in processing subsystem 102. Memory subsystem 104 may store one or more program modules or computer-program mechanisms with instructions for operations that implement the energy estimation (such as energy-estimation program module 110) and/or one or more software applications 112, either of which may be executed by processing subsystem 102.

In some embodiments, memory subsystem 104 is coupled to one or more high-capacity mass-storage devices (not shown). For example, memory subsystem 104 can be coupled to a magnetic or optical drive, a solid-state drive, or another type of mass-storage device. In these embodiments, memory subsystem 104 can be used by portable electronic device 100 as fast-access storage for often-used data, while the mass-storage device is used to store less frequently used data.

Networking subsystem 106 includes one or more devices (such as communication subsystems or chips) configured to couple to and communicate on a wired and/or wireless network (i.e., to perform network operations), including one or more cellular packet data and cellular-telephone networks (e.g., 3G/4G networks such as 1x, UMTS, LTE, EVDO, CDMA, GSM, etc.), and WLAN networks, including portions based on standards described in IEEE 802.11 (such as a Wi-Fi networking system). Networking subsystem 106 can include a Bluetooth networking system, which may include Bluetooth low energy (BLE) capabilities, a universal serial bus (USB) networking system, an Ethernet networking system, and/or another networking system. Networking subsystem 106 includes processors, controllers, radios/antennas, sockets/plugs, and/or other devices used for coupling to, communicating on, and handling data and events for each supported networking system. Networking subsystem 106 will be discussed in more detail below with respect to FIG. 2.

Processing subsystem 102, memory subsystem 104, and networking subsystem 106 are coupled using bus 108. Bus 108 is an electrical, optical, or electro-optical connection that the subsystems can use to communicate commands and data among one another. Although only one bus 108 is shown for clarity, different embodiments can include a different number or configuration of electrical, optical, or electro-optical connections among the subsystems.

Although shown as separate subsystems in FIG. 1, in some embodiments, some or all of a given subsystem can be integrated into one or more of the other subsystems in portable electronic device 100. Although alternative embodiments can be configured in this way, for clarity we describe the subsystems separately.

Portable electronic device 100 can be (or can be included in) any device with at least one processing subsystem and one networking subsystem. For example, portable electronic device 100 can be (or can be included in): a laptop computer, a media player, a subnotebook/netbook, a tablet computer, a cellular phone, a personal digital assistant (PDA), a smartphone, a toy, a controller, a network appliance, and/or another electronic device.

Portable electronic device 100 may also include one or more additional processing subsystems 102, memory subsystems 104, and/or networking subsystems 106. Additionally, one or more of the subsystems may not be present in portable electronic device 100. Furthermore, although we use specific subsystems to describe portable electronic device 100, in alternative embodiments, portable electronic device 100 may include one or more additional subsystems that are not shown in FIG. 1. For example, portable electronic device 100 may also include, without limitation: a data collection subsystem, an alarm subsystem, an audio subsystem, a display subsystem and/or an input/output (I/O) subsystem. Moreover, portable electronic device 100 may include a display subsystem which can include any type of display technology such as: a light-emitting diode (LED), an organic light-emitting diode (OLED), a liquid crystal display (LCD), such as thin film transistor (TFT), and/or other types of display technology. In addition, the display subsystem may include mechanisms for processing data, and/or other information for display and may also include an audio subsystem for producing sound. The display subsystem may also include touchscreen technology for inputting information into portable electronic device 100 (thus, a display in portable electronic device 100 may include a multi-touch user interface). In some embodiments, one or more memory caches and/or processing systems or other hardware modules may be located in the display subsystem.

### Networking Subsystem

FIG. 2 presents a block diagram illustrating a networking subsystem in a portable electronic device that includes one or more cellular subsystems and a WLAN subsystem in accordance with described embodiments. Networking subsystem 106 includes WLAN subsystem 208 and one or more cellular subsystem(s) 202, which includes both cellular packet data subsystem 204 and cellular voice subsystem 206.

As discussed previously, networking subsystem 106 includes processors, controllers, radios/antennas, sockets/plugs, and/or other devices used for coupling to, communicating on, and handling data and events for each supported networking system, including WLAN and cellular voice information and packet data. For clarity, each subsystem within networking subsystem 106 is depicted separately. Note, however, that in some embodiments one or more of cellular subsystem 202 and WLAN subsystem 208 may share systems, hardware, software, and/or firmware. Additionally, for clarity cellular packet data subsystem 204 and cellular voice subsystem 206 are depicted separately, but in some embodiments they may share some hardware, systems, software, and/or firmware. For example, cellular packet data subsystem 204 and cellular voice subsystem 206 may share a common antenna and resource manager (e.g., in cellular subsystem 202). Also, note that WLAN subsystem 208 and cellular subsystem 202 may be implemented on different chips, and in some embodiments cellular subsystem(s) 202 and WLAN subsystem 208 may each communicate through bus 108, but may not communicate directly with each other.

As noted previously, in FIG. 1 processing subsystem 102 may execute energy-estimation program module 110. This energy-estimation program module may instruct firmware stored in memory 210 (such as control module 212) and executed in networking subsystem 106 (e.g., by an embedded processor) to store logs 214 of hardware-state information and software-state information. These logs may be regularly provided to energy-estimation program module 110 in FIG. 1 so that the energy-consumption can be estimated.

### Operating System

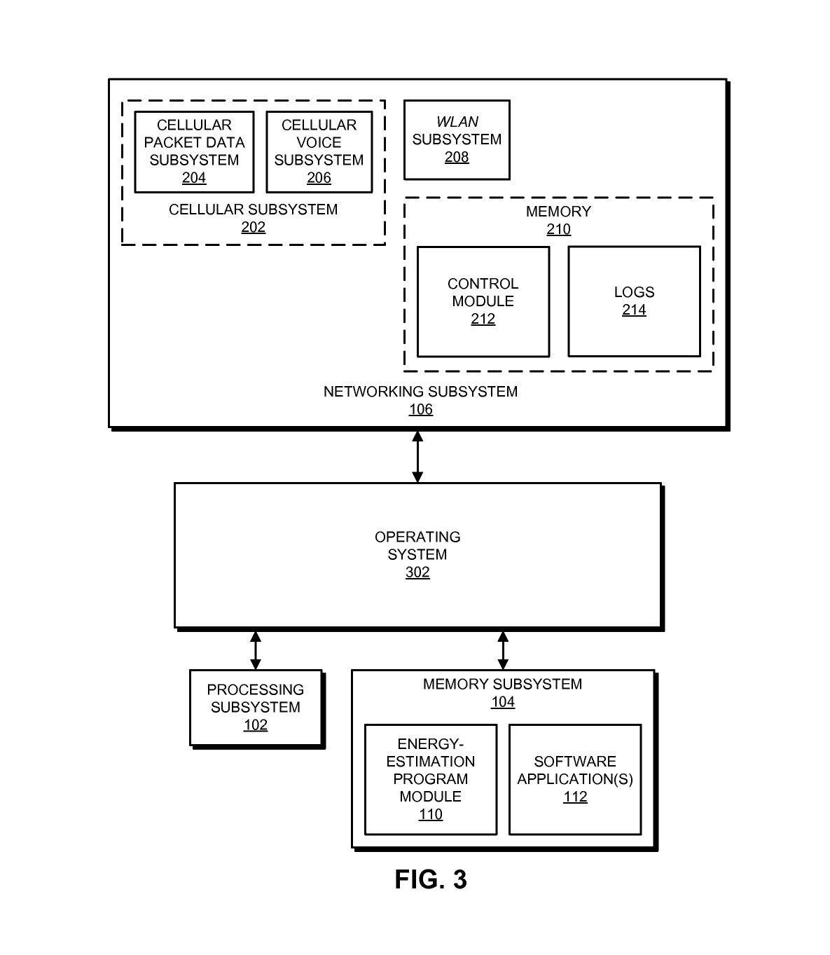

FIG. 3 presents a block diagram illustrating operating system 302 in accordance with the described embodiments. In some embodiments, operating system 302 is stored (as program code) in memory subsystem 104 and executed by processing subsystem 102.

In general, operating system 302 serves as an intermediary between system hardware in portable electronic device 100 (e.g., subsystems 102-106) and software applications executed by processing subsystem 102, such as energy-estimation program module 110 and/or one or more software application(s) 112 (which can be, for example, an email application, a web browser, a text messaging application, a voice communication application, and/or a game application). For example, operating system 302 can be, but is not limited to, the iOS operating system or OS X operating system, both from Apple Inc. of Cupertino, Calif.; Windows Phone from Microsoft Corporation; Android from the Open Handset Alliance; the FreeBSD operating system from The FreeBSD Foundation of Boulder, Colo.; or another operating system. Operating systems and their general functions are known in the art and hence are not described in detail.

To manage the transfer of packets to and from software applications 112 and operating system 302 in portable electronic device 100 using an appropriate interface circuit or communication subsystem in networking subsystem 106, operating system 302 maintains one or more network or communication protocol stacks (not shown) that each includes a number of logical layers. For example, the operating system can maintain a cellular protocol stack and/or an Internet protocol stack, which includes the link, Internet, transport, and application layers. As another example, the operating system can maintain a protocol stack based on the OSI model, which includes: the application, presentation, session, transport, network, data-link, and physical layers. At corresponding layers of the protocol stack, the operating system includes control mechanisms and data structures for performing the functions associated with the layer. The functions associated with each of the layers in the communication protocol stack are known in the art and hence are not described in detail.

### Low-Power Associated Sleep Mode

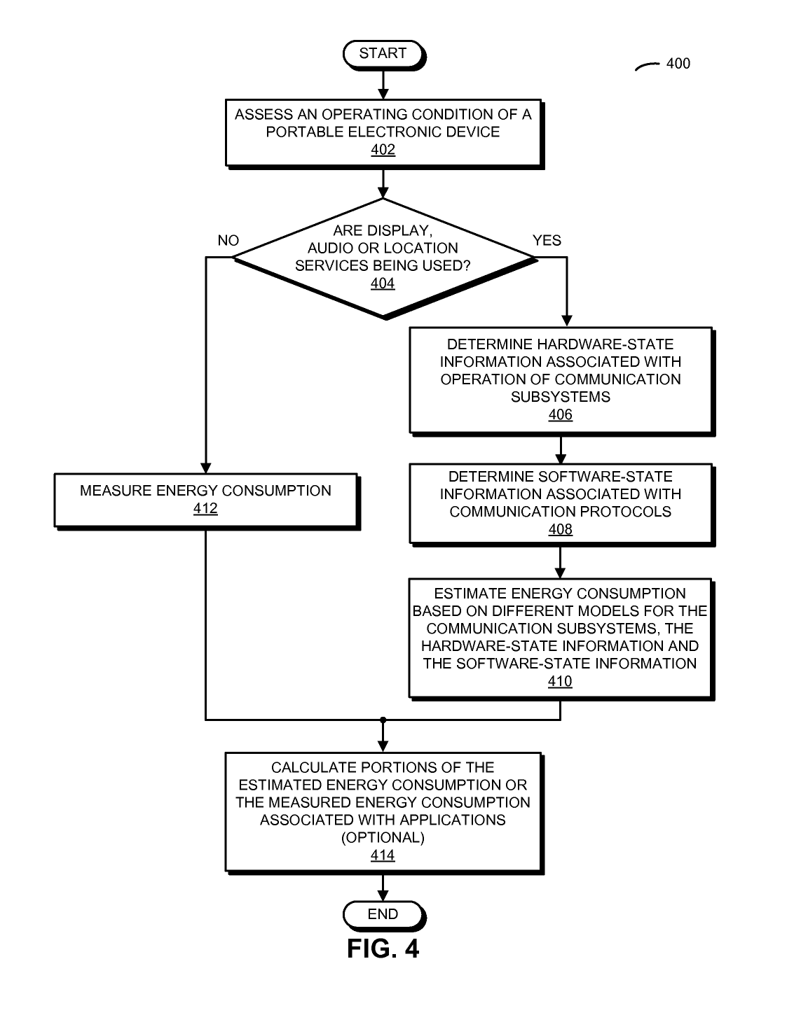

FIG. 4 presents a flow chart illustrating a method 400 for estimating energy consumption of a portable electronic device (such as portable electronic device 100 in FIG. 1) when the portable electronic device wirelessly communicates with at least another electronic device using the communication subsystems that implement the different communication protocols. During this method, the portable electronic device may assess an operating condition of the portable electronic device (operation 402). For example, the portable electronic device may assess use of a display, audio and/or location services. Based on the assessed operating condition, the portable electronic device may either measure or estimate the energy consumption. In particular, if the display is on, audio is being used, and location services (such as the Global Positioning System, multilateration, etc.) are being used (operation 404), the portable electronic device determines hardware-state information associated with operation of the communication subsystems (operation 406) and software-state information associated with the communication protocols (operation 408). Then, the portable electronic device estimates the energy consumption based on different models for the communication subsystems, the hardware-state information and the software-state information (operation 410).

Alternatively, if the display is off, audio is not being used, and location services are not being used (operation 404), the portable electronic device measures the energy consumption of the portable electronic device (operation 412).

Moreover, the portable electronic device may optionally calculate the portions of the estimated energy consumption or the measured energy consumption associated with applications executing on the portable electronic device (operation 414).

In some embodiments, there may be additional or fewer operations in FIG. 4. For example, the estimated energy consumption or the measured energy consumption may also be used to manage the battery and to update battery information presented to a user of the portable electronic device. Furthermore, the order of the operations may be changed, and/or two or more operations may be combined into a single operation.

In an exemplary embodiment, the energy-estimation technique (which is sometimes referred to as ‘power modeling’) is used to estimate the energy consumed for each background update to different software applications on a portable electronic device. The portable electronic device has different subsystems, including: a system on chip (SOC), a display subsystem, one or more baseband chips (with different communication subsystems), a Wi-Fi chip, an audio subsystem, and/or other subsystems. While there are good models of the energy consumption for some of these subsystems, for some of the subsystems there are insufficient hooks in the hardware to provide accurate models. As an illustration, in the discussion that follows radio energy estimation (for the one or more baseband chips and the Wi-Fi chip) is used as an illustrative example.

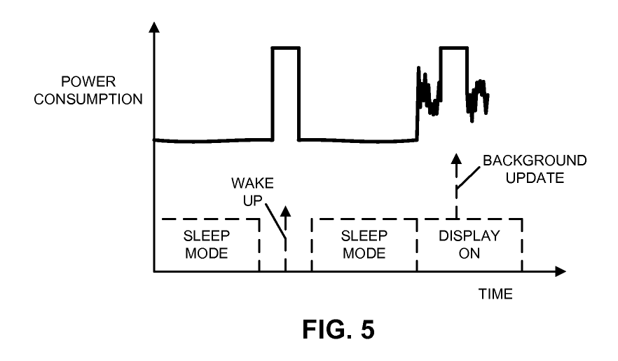

As shown in FIG. 5, which presents a drawing illustrating power consumption as a function of time for a portable electronic device (such as portable electronic device 100 in FIG. 1), if an update is happening on one of the baseband chips, there will be some power usage (as indicated by the plateaus and valleys in the power consumption as a function of time) that coincides with activity of the portable electronic device, such as: display on and processor subsystem awake, display off with audio on, use of location services, display on, etc.). If the display is off and the processor subsystem is not being used for audio or location services, and if there is an update start and an update end, the energy consumed can be determined by measuring the total energy consumption of the portable electronic device using a gas gauge, which is a utility that estimates how much energy in the battery has been used (i.e., by measuring the energy consumption). The gas gauge provides an accurate sampling of the energy consumed by the one or more baseband chips, the Wi-Fi chip and the SOC associated with a background update. Thus, if the processor subsystem is on and the display is off (or inactive), models of the energy consumption are not needed to determine the energy consumption.

However, if an update is happening with just the display on or with the display off and with audio or location services, the gas gauge may not provide an accurate measure of the energy consumption because of other user activity, and it will be difficult to attribute the energy consumption to the different software applications that are being executed. Consequently, models may be used to estimate the energy consumption of the one or more baseband chips and the Wi-Fi chip, and the gas gauge may be used as an upper bound on the energy consumption.

In general, there is a different model for each of the chips/communication subsystems. Moreover, for each chip/communication subsystem, there is a different model for each radio access technology/communication protocol supported. For a given communication subsystem and radio access technology, the corresponding model includes information specifying hardware states (i.e., assigns a power cost per hardware state) and information specifying software/communication protocol states (i.e., assigns a power cost per software state). Note that the software/communication protocol states are used because there are typically insufficient hooks available in the information specifying the hardware states. Thus, the model may start with the software/communication protocol state and may use the hardware state(s) as a backup.

In the model, a variety of inputs are used, including the length of time the baseband chip is in an active or connected mode and the power used in the active or connected state (e.g., the base power when there is sufficient signal strength and the incremental power as function of the transmit power). Moreover, the portable electronic device may log a histogram of the transmit power when it is transmitting (such as power-consumption values between 0 and 24 dBm along with counters for the amount of time spent in different states). For example, for a universal mobile telecommunications standard (UMTS)/W-CDMA communication protocol, there may be counters for the power consumption associated with the forward access channel (FACH) protocol and for the additional transmit power associated with the dedicated transport channel (DCH) protocol.

Alternatively, for LTE, if the connected discontinuous reception (CDRX) mode is off, an inactivity timer and the time spent in the connected mode and the power consumed in the connected state may be used in the model. However, if CDRX is enabled, the model may also use the intermittent sleep time, i.e., the times after transmissions when the portable electronic device uses low power but is not disconnected. In particular, for LTE, there is higher power consumption in the connected state, but the networking subsystem may go to sleep when buffers are empty (so the transceivers are shut down but the core is still running). Thus, there may also be lower power consumption (close to the idle state) in between transmissions.

The models may be used for on-device energy estimation. For example, if the portable electronic device transmits for 10 s using W-CDMA, the associated first energy consumption may be the base protocol power consumption times the connect time plus the transmit energy. Similarly, for the FACH protocol, a second energy consumption may be the associated power consumption times time. The total energy consumption of the radio may be the sum of the first energy consumption and the second energy consumption.

Because in principle there is energy consumed to collect the data used by the models, the energy-estimation technique may be implemented with a low overhead, e.g., the necessary data may be transferred in chunks from the counters. For example, the one or more baseband chips in the networking subsystem may collect the data and store it in a cache. This data may be transferred to the processing subsystem when: a background update request is received, and/or when a snapshot of current counters is taken (such as the amount of time in the connected mode, the amount of time in sleep, the amount of time in different transmit states, etc.). Note that a snapshot may be taken every five minutes. Alternatively, if an update ends sometime after five minutes have elapsed, a snapshot may be taken. Then, the data in the cache in the networking subsystem may be transferred to the processing subsystem and the cache may be emptied. Next, the energy consumption may be computed using the model. Moreover, a response may be provided to the energy-estimation program module indicating that the update to software application A consumed X units of energy.

If two software applications are updating at the same time, a snapshot may be taken at each time a software-application update starts and ends. However, if two software applications are updating concurrently, it may be difficult to allocate the appropriate portions of the estimated energy consumption to the two software applications because there may be insufficient granularity in the snapshots. This accounting problem (the baseband is a shared resource) may be addressed: by dividing the estimated energy consumption in half, and/or based on the data usage associated with each of the software applications (such as bytes communicated per software application per communication protocol). Alternatively or additionally, the models for each software application may be used in isolation, and the computed estimated energy consumption for each of the software applications may be used to allocate the total estimated energy consumption to the different software applications.

A similar approach to that discussed previously may be used to estimate the energy consumption of the Wi-Fi chip. However, a different model may be used. For older Wi-Fi chips, the hardware-state information may be limited to the chip awake time. Nonetheless, it is also possible to use the download/upload data to estimate the transmit/receive duty cycle, as well as the throughput (how much of the bandwidth is being used) based on a knowledge of the communication protocol. For example, for IEEE 802.11a, Wi-Fi can accommodate a variety of data rates. While the preamble and the header in the packets have fixed durations, the time needed to convey the data in the packets varies with the data rate. Using the knowledge of the throughput, the energy consumption can be bounded in the corresponding model.

In the preceding description, we refer to ‘some embodiments.’ Note that ‘some embodiments’ describes a subset of all of the possible embodiments, but does not always specify the same subset of embodiments.

The foregoing descriptions of embodiments have been presented for purposes of illustration and description only. They are not intended to be exhaustive or to limit the present description to the forms disclosed. Accordingly, many modifications and variations will be apparent to practitioners skilled in the art. Additionally, the above disclosure is not intended to limit the present description. The scope of the present description is defined by the appended claims.

What is claimed is:

1. A portable electronic device, comprising:
an antenna;
an interface circuit, coupled to the antenna, configured to wirelessly communicate with at least another electronic device using communication subsystems that implement different communication protocols;
a processor; and
memory, wherein the memory stores a program module, and wherein the program module is configured to be executed by the processor to estimate energy consumption of the portable electronic device, the program module including:
instructions for determining hardware-state information associated with operation of the communication subsystems;
instructions for determining software-state information associated with the communication protocols; and
instructions for estimating the energy consumption based on different models for the communication subsystems, the hardware-state information and the software-state information.

2. The portable electronic device of claim 1, wherein the communication protocols include multiple communication protocols in a list including: wideband code division multiple access, long-term evolution, evolution-data optimized, global system for mobile communication, and Wi-Fi.

3. The portable electronic device of claim 1, wherein determining the hardware-state information and determining the software-state information involve configuring firmware in the communication subsystems to log the hardware-state information and the software-state information and to provide the logged information to the processor.

4. The portable electronic device of claim 3, wherein the logged information is provided after one of: a time interval, a triggering event, when a memory in the interface circuit is full, and when the processor transitions from a sleep mode to an active mode.

5. The portable electronic device of claim 4, wherein the triggering event includes a software update.

6. The portable electronic device of claim 1, wherein the hardware-state information includes an amount of time spent in an active mode, an amount of time spent in a sleep mode, and a transmit/receive duty cycle.

7. The portable electronic device of claim 1, wherein the hardware-state information includes throughput for a connection to at least the other electronic device.

8. The portable electronic device of claim 1, wherein the software-state information includes an amount of time spent in different software states associated with the communication protocols.

9. The portable electronic device of claim 1, wherein the memory further stores multiple applications; and
wherein the program module further includes instructions for calculating the portions of the estimated energy consumption associated with the applications.

10. The portable electronic device of claim 1, wherein the program module further includes instructions for measuring the energy consumption;
wherein the portable electronic device further includes a display;
wherein the memory further includes multiple applications;
wherein, when the display is active, the estimated energy consumption is based on the models, the hardware-state information and the software-state information;
wherein, when the display is inactive and the processor executes an application that uses one of: audio and location services, the estimated energy consumption is based on the models, the hardware-state information and the software-state information; and
wherein, otherwise, the estimated energy consumption is based on the measured energy consumption.

11. A computer-program product for use in conjunction with a portable electronic device, the computer-program product comprising a non-transitory computer-readable storage medium and a computer-program mechanism embedded therein, to estimate energy consumption of the portable electronic device when the portable electronic device wirelessly communicates with at least another electronic device using communication subsystems that implement different communication protocols, the computer-program mechanism including:
instructions for determining hardware-state information associated with operation of the communication subsystems;
instructions for determining software-state information associated with the communication protocols; and
instructions for estimating the energy consumption based on different models for the communication subsystems, the hardware-state information and the software-state information.

12. The computer-program product of claim 11, wherein the communication protocols include multiple communication protocols in a list including: wideband code division multiple access, long-term evolution, evolution-data optimized, global system for mobile communication, and Wi-Fi.

13. The computer-program product of claim 11, wherein determining the hardware-state information and determining the software-state information involve configuring firmware in the communication subsystems to log the hardware-state information and the software-state information and to provide the logged information to the processor.

14. The computer-program product of claim 13, wherein the logged information is provided after one of: a time interval, a triggering event, when a memory in the interface circuit is full, and when the processor transitions from a sleep mode to an active mode.

15. The computer-program product of claim 11, wherein the hardware-state information includes an amount of time spent in an active mode, an amount of time spent in a sleep mode, and a transmit/receive duty cycle.

16. The computer-program product of claim 11, wherein the hardware-state information includes throughput for a connection to at least the other electronic device.

17. The computer-program product of claim 11, wherein the software-state information includes an amount of time spent in different software states associated with the communication protocols.

18. The computer-program product of claim 11, wherein the computer-program mechanism further stores multiple applications; and
wherein the computer-program mechanism further includes instructions for calculating the portions of the estimated energy consumption associated with the applications.

19. The computer-program product of claim 11, wherein the computer-program mechanism further includes instructions for measuring the energy consumption;
wherein the portable electronic device further includes a display;
wherein the computer-program mechanism further includes multiple applications;
wherein, when the display is active, the estimated energy consumption is based on the models, the hardware-state information and the software-state information;
wherein, when the display is inactive and a processor in the portable electronic device executes an application that uses one of: audio and location services, the estimated energy consumption is based on the models, the hardware-state information and the software-state information; and
wherein, otherwise, the estimated energy consumption is based on the measured energy consumption.

20. A method for estimating energy consumption of a portable electronic device when the portable electronic device wirelessly communicates with at least another electronic device using communication subsystems that implement different communication protocols, wherein the method comprises:
determining hardware-state information associated with operation of the communication subsystems;
determining software-state information associated with the communication protocols; and
estimating the energy consumption based on different models for the communication subsystems, the hardware-state information and the software-state information.
